(19) United States
(12) Patent Application Publication
(10) Pub. No.: US 2009/0193229 A1
(43) Pub. Date: Jul. 30, 2009

(54) HIGH-INTEGRITY COMPUTATION ARCHITECTURE WITH MULTIPLE SUPERVISED RESOURCES

(75) Inventors: Tarik Aegerter, Seine Port (FR); Patrice Toillon, Fourqueux (FR)

Correspondence Address: DARBY & DARBY P.C., P.O. BOX 770, Church Street Station, New York, NY, 10008-0770, US

(73) Assignee: Thales, Neuilly Sur Seine (FR)

(21) Appl. No.: 12/333,541

(22) Filed: Dec. 12, 2008

(30) Foreign Application Priority Data
Dec. 14, 2007 (FR) 0708737

(51) Int. Cl. G06F 15/76; G06F 9/06

(52) U.S. Cl. 712/30; 712/E09.003

(57) ABSTRACT

The present invention relates to computers, the undetected errors of which have a very low rate of occurrence (approximately 10⁻⁹ per time unit). This relates in particular to the embedded computers on aircraft that run critical applications such as the automatic pilot, flight management, fuel management or terrain collision prevention. Two or more computation lanes or sections are provided and the exchanges are authorized either on the production or on the consumption of the data by each of the lanes. It is also possible to provide a predefined authorization cycle. The authorization to transfer the datum is given according to a binary comparison logic in the case of two lanes. In the case of more than two lanes, the authorization can be given either by a binary comparison logic or by a majority logic depending on whether the integrity or the availability of the computation system is prioritized.

### FIELD OF THE INVENTION

This application claims the benefit of French Application No. 0708737, filed on Dec. 14, 2007, the entire disclosure of which is incorporated by reference in its entirety.

The invention relates to the context of the digital processing units of avionics computers for which a high degree of integrity of the processed data is required. The solution proposed according to several alternatives or versions makes it possible to achieve objectives of 10E-9 per hour of flight of erroneous data undetected consistent with the dependability objectives of the avionics applications and functions hosted by this type of computer.

### BACKGROUND

This high integrity is conventionally obtained by providing several subsystems of computers on which one and the same application will run in parallel. Each computer comprises its own processor provided with a clock and working memories and is directly connected to the network of the various computers that exchange data. One of the computers executes the supervision function. The two subsystems are loosely synchronized; in other words, synchronized to a few application cycles: some 10 ms for example often by dedicated links. The comparison of the data produced by the main subsystem is conducted on the basis of acceptance windows (range of values accepted according to the variable concerned). Because of this, it is possible that certain errors on intermediate data will not be detected and can have ultimate consequences on data that they are used to generate. An error on the critical datum will therefore be detected later, whereas it was already present in intermediate data for several computation cycles. This supervision can therefore be qualified as “loose”, and presents a high error reaction time. Another type of implementation exists that makes it possible to improve the reaction time. It consists in using a so-called “dual-lane” or “multi-lane” architecture, comprising two or more than two processors, which are themselves synchronized. The comparisons that can then be performed systematically on each individual data processing operation performed by the two or more processors. The problem posed by this approach is that it is very comparison-intensive, and all the more difficult to implement when the processors are fast. The comparisons are in effect applied to all the individual processing operations executed (code and data) by the processors, which offers no benefit from the point of view of the overall integrity of the function and can adversely affect availability. It should also be noted that the trend in microprocessor architectures is mostly oriented towards an integration, within the same chip of the processor, of its bridge and its memory controller, so rendering detection impossible on the buses local to the processors since they are buried within the chip.

The present invention resolves this problem by a processing architecture that is optimized in terms of integrity and availability.

### SUMMARY OF THE INVENTION

To this end, embodiments of the invention disclose a processing device comprising at least two computation lanes or sections, each provided with a central processing unit, said lanes being synchronized with each other and having an area of random-access memory, also comprising at least one data exchange memory area for exchanging data between lanes and between the central processing units and an external communication network, and being characterized in that it also comprises a supervision module parameterizably supporting different methods of comparing the data of said lanes.

Advantageously, the data exchange memory areas and the supervision module are incorporated within a single interface management module connected on the one hand to each of the computation lanes and on the other hand to the external network.

Advantageously, the comparison of the data of the two lanes is performed by a bit-by-bit comparator with parallel structure comprising an individual comparator for each data bit within groups of bits of parameterizable size.

Advantageously, the comparison function can be tested.

Embodiments of the invention also disclose a method of processing at least one computer application running in parallel on at least two computation lanes, each provided with a central processing unit, organized in partitions, said lanes being synchronized with each other and having an area of random-access memory, said method comprising several steps of exchanging data between data exchange memory areas for exchanging data between partitions of a central processing unit and between the central processing units and an external communication network, and being characterized in that it also comprises steps of supervision of a parameterizable subset of said exchanges according to a criterion of comparison of the data of said lanes.

Advantageously, the subset of the exchanges subject to comparison is all the data produced by the computation lanes.

Advantageously, the subset of the exchanges subject to comparison is all the data consumed by the computation lanes.

Advantageously, the subset of the exchanges subject to comparison is all the data present in the mailbox of the network subscriber at selected time slots.

Advantageously, the subset of the exchanges subject to comparison excludes programmed procedures of the computer application.

Advantageously, the subset of the exchanges subject to comparison excludes data with a reserved specific memory space.

Advantageously, the comparison is performed bit-by-bit within each word.

Advantageously, the comparison is performed bit-by-bit within each block of a predetermined number of several words.

Advantageously, the computer processing method comprises no more than two lanes.

Advantageously, in the computer processing method that comprises no more than two lanes, the transfer is not authorized if the data of the two lanes that are compared are not identical.

Advantageously, in the computer processing method which comprises no more than two lanes, the transfer is authorized if the data of the two lanes that are compared are identical, the transmitted datum being that of one of the two lanes for which the selection is parameterizable.

Advantageously, the computer processing method comprises more than two lanes.

Advantageously, in the computer processing method that comprises more than two lanes, the transfer is not authorized if no lane satisfies a vote criterion between the data of all the lanes.

Advantageously, in the computer processing method that comprises more than two lanes, the transfer of the datum of the lane having satisfied a vote criterion between the data of all the lanes is authorized.

Thus, according to embodiments of the invention, two data processing subsystems perform the same operations (by duplication of the resources and simultaneous parallel executions of the processing operations) and a “supervisor” function based on a “comparator”, connected in write mode and in read mode to all of the subsystems, thus checks the consistency of the data computed and consumed by these subsystems in particular with regard to their communications over the external network.

A preferred embodiment consists in incorporating, in a single component, the “supervisor” function within the building block for connecting the computer with the external network, called “end-system” function.

Embodiments of the invention present a number of advantages. Firstly, the supervision function can be implemented simply by comparators consisting of inexpensive logic gate assemblies. Furthermore, it is easy to incorporate these comparators in the circuit that links the processors to the communication network, which can be an Ethernet network or an AFDX (Avionics Full DupleX) bus. Lastly, the architecture can easily be transposed from a two-processor architecture to an N-processor architecture, which makes it possible to further increase the integrity rate.

### BRIEF DESCRIPTION OF THE DRAWINGS

Embodiments of the invention will be better understood, and its various characteristics and benefits will become apparent, from the description that follows of a number of exemplary embodiments and its appended figures, in which:

FIGS. 1A and 1B represent two processing architectures according to the prior art;

FIG. 2 represents a theoretical block diagram of the processing architecture;

FIG. 3 represents an embodiment of the processing architecture in the case of two processing lanes;

FIG. 4 represents an embodiment of the supervision module in the case where said module is incorporated in the interface management module of the processing device;

FIG. 5 represents a simplified flow diagram of the processing operations;

FIG. 6 represents various embodiments of the invention according to the target integrity objectives.

Unless stated otherwise, in the description and the figures, the symbols, acronyms and abbreviations have the meanings as indicated in the table below.

| Symbol/Abbreviation | Meaning |
|---|---|
| AFDX | Avionics Full DupleX switched Ethernet |
| AP | Auto Pilot |
| COM | Command part of a dual computation subsystem |
| CPU | Central Processing Unit |
| E/S | End System, for network connection |
| FMS | Flight Management System |
| IMA | Integrated Modular Avionics |
| MAC | Medium Access Control |
| Mlbx | Mailbox |
| MON | Monitor part of a dual computation subsystem |
| PCI | Personal Computer Interface |
| RAM | Random Access Memory |
| RM | Redundancy Management |
| RX | Receive module |
| SUP | Supervision module |
| TX | Transmit module |
| UDP | User Datagram Protocol |

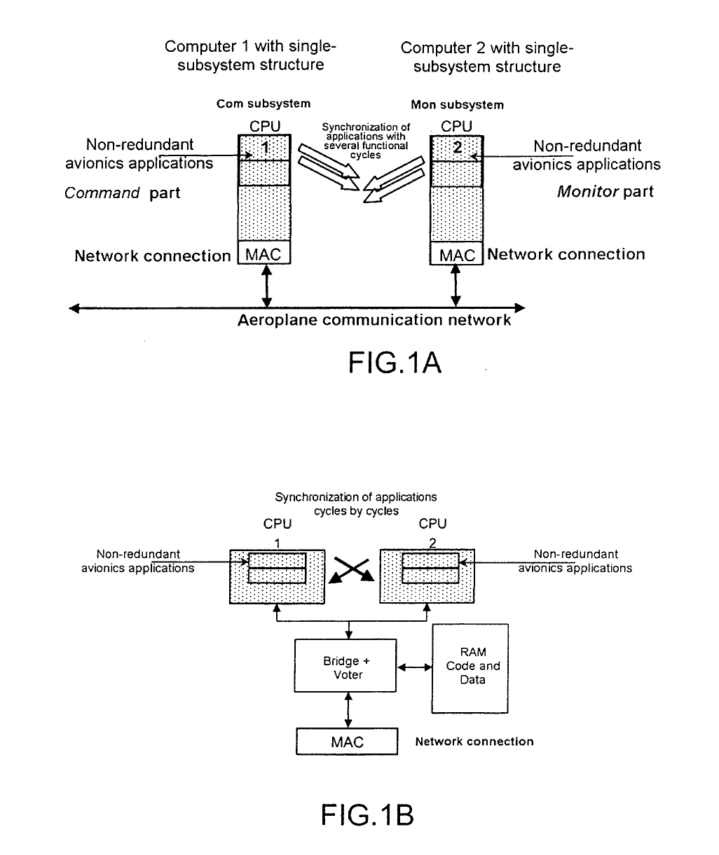

FIG. 1A represents an architecture of the prior art, commonly implemented and making it possible to achieve the high-integrity objective. This architecture is based on an association with two avionics computers that are identical or very similar, each with internal single-subsystem structure. One of the computers executes the avionics application (the COM subsystem). The second computer executes an image avionics application (identical, but without data output except for sanction information), and compares its results to those of the COM subsystem. If there is any difference, the MON subsystem deactivates the COM subsystem. A number of avionics applications can be executed on each of the subsystems. The two subsystems are loosely synchronized; in other words, synchronized to a few application cycles: some 10 ms for example, often by dedicated links. The comparison of the data produced by the COM subsystem relates to critical values and is based on an acceptance window (range of values accepted according to the variable concerned). The comparison is therefore carried out subsequently and after a few cycles. This solution requires the presence of two complete modules and their interconnection via an on-board network.

FIG. 1B represents another architecture of the prior art also making it possible to achieve the high-integrity objective. This architecture is based on an association with two processing units with strict time coupling. This architecture requires a strong time relationship between the two processing units because both the code that is executed and the data that is produced/consumed are checked/voted. Generally, the check/vote takes place on the access path to the central memory.

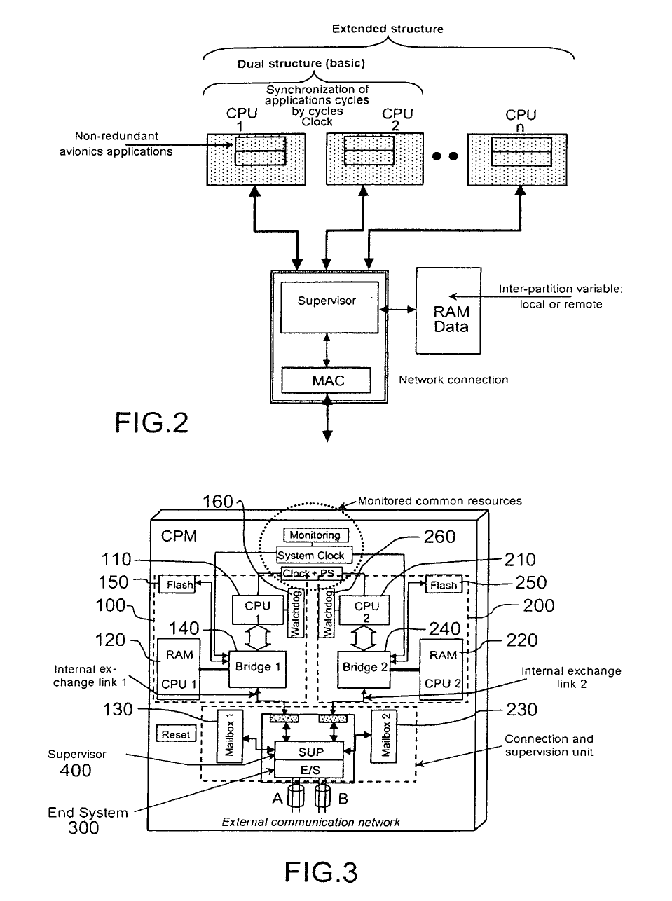

FIG. 2 represents a processing architecture according to an embodiment of the invention. The basic structure uses two central processing units (CPU) which drive two lanes or computation subsystems. The extended structure uses n CPU. The unique supervision unit checking the integrity processes only the data and variables, that is, it does not process the code executed. This architecture makes it possible to process the data intended for the network and also the data between partitions local to the equipment. This choice makes it possible to compare data between partitions at a rate consistent with their processing (when the data is produced or consumed) and is applicable both for exchanges between partitions of one and the same module and between partitions distributed over several modules. A multiprocessor or “multi-lane” architecture makes it possible to further increase the integrity without compromising the availability or to increase the availability with constant integrity, as explained hereinbelow in the description. The detailed operation of these architectures is also explained hereinbelow in the description. It is also possible to disengage, by secure configuration (hardware and/or software) of the comparator, the supervision function, and have the two subsystems operate in dual-simplex mode (the two subsystems do not perform exactly the same processing operations) or in single-simplex mode (just one of the two subsystems is active). The claimed solution requires an ordered execution of the operations between the subsystems, and a blocking comparison (with acceptance time window) of the peer data, without these data necessarily being obtained from a synchronization to the nearest clock cycle. It is possible to ensure the synchronization by providing a clock that is common to all the CPUs.

The supervision function is connected in write mode and in read mode to all the subsystems (two or n) and checks the consistency of the data produced or consumed by these subsystems, either, in the first case, before they are sent over the network, or, in the second case, when they are routed from the network to the computation lanes. The supervision module is therefore advantageously positioned between the network interface and the computation lanes.

FIG. 3 describes the target architecture in the case of two lanes or processing subsystems (subsystem/lane 100 and subsystem/lane 200), each comprising separate resources:
a central processing unit (CPU 110, 210);
a bridge (140, 240) forming the data interconnection and checking unit, which bridge can be incorporated or not in the CPU;
a CPU RAM (120, 220);
a non-volatile storage memory for the CPU code (150, 250);
a watchdog (160, 260) which handles the behavioural supervision of the CPUs.

Each lane is connected to a supervision unit 400 that is common to these two lanes, which handles the “supervisor” function for the data from these two lanes according to several possibilities or modes that are detailed hereinbelow. The connection unit 300 downstream of the supervision unit, also common to both lanes, handles the “end-system” (E/S) function for external connection. The grouping together of the supervision unit and the network connection unit in a connection and supervision unit is an advantageous option which makes it possible to obtain an integrated solution that is optimized to satisfy the on-board-installation feasibility constraints (crucial nature of the integration regarding the surface area occupied, thermal dissipation and cost, notably).

One or more exchange memories 130, 230, for storing the data exchanged between local or remote partitions, are associated with the supervision unit. These exchange memory areas are positioned alongside the supervision unit. The supervision unit is connected to each of the subsystems independently by an internal, dedicated exchange link.

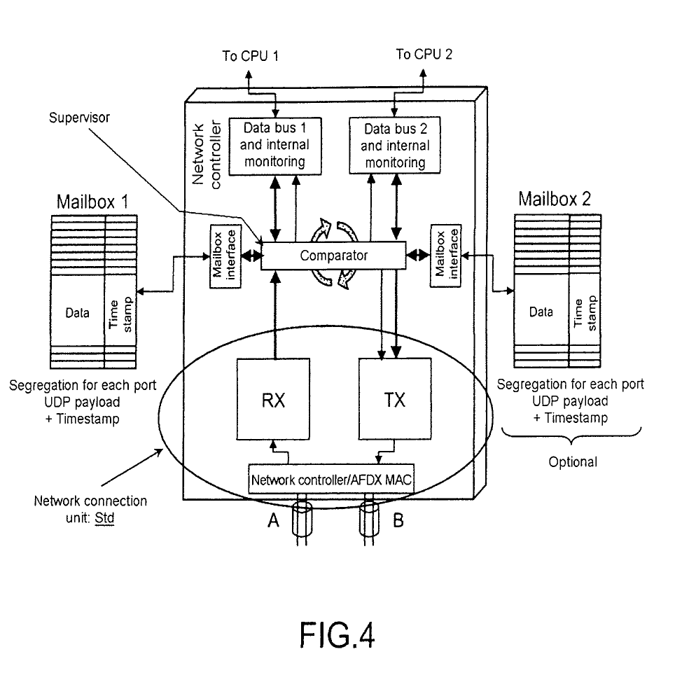

FIG. 4 provides a more detailed description of the supervision module in the two-lane embodiment. The supervision is based on a simple comparison of the data according to various possibilities or modes:
on the production of an item of information supplied by both lanes;
on the consumption of an item of information by both lanes;
independently, at a predetermined frequency.

The supervision of the commands is based on a simple comparison on production of this command—the concept of consumption of the command being meaningless.

In the embodiment represented here, where the connection unit and the supervision module are incorporated in one and the same circuit, the latter is connected via two separate data buses to the two processing processors (internal exchange links 1 and 2). These links will advantageously be implemented by high-speed serial digital links (of express, RapidIO, and other such types) or by parallel links (PCI, etc.), each of these links being internal or not to the processing module. This unit is connected to the external communication network via a single standard interface that has no specific features compared to the solutions of the prior art. The interface management module comprising, in the embodiment represented here, the supervision module, is connected to one or two exchange memories (mlbx 130, 230), designed to temporarily store the messages originating from or leaving for the network (or internal to the module) and the associated checking information. The device can operate with one or two mlbx, but the architecture with two mailboxes is, however, necessary in the preferred operating mode in which the comparison of the data is performed on consumption by the computation lanes. The data should in this case be stored when coming from the network or from another partition before comparison. The mailboxes can be implemented in a single memory, with dedicated areas; each dedicated area being structured so as to isolate the data from the different partitions (allocation by communication port). Each memory area also comprises a time-stamping area making it possible to ensure that the comparisons are indeed performed on the data produced or consumed by the lanes in the same cycle.

In the two-lane mode that is of interest here, the check on the integrity relies on a comparison of certain data produced or consumed by the two lanes. In the case of 32-bit CPUs processing 32-bit data words, which is the current state of the art in avionics, 32 bit-by-bit logic comparison units are provided. Any bit error causes a comparison error on the word, demonstrating the exhaustive (non-probabilistic) nature of the comparison. The performance of the solution is constrained neither by the size of the word nor by the size of the message. The comparison is advantageously continuous in dual mode, which means that it is not triggered. This option simplifies the implementation. It is possible, however, to envisage triggering the comparison, notably in the predetermined cycle independent operating mode. Preferably, the result of the comparison is taken into account by the consumer of the information, that is, either by the “end system”, or by the subsystems.

This function is critical because the integrity is based on the quality of its behaviour. The integrity of this function should be at least better than two decades compared to the overall computer integrity objective (10e-11/10e-09). An equivalent of 100 logic gates and a testability capability contributes to this objective.

A positive comparison validates the authorization of the transfer of the datum whereas a negative comparison invalidates it, according to the modalities explained below. The authorization function can be applied either to the production or to the consumption of the data, or independently.

The selection of the mode of application of the authorization function, namely:

on production of the data, on consumption of the data or independently, can be managed in different ways:
either it is an initial implementation choice set on designing the component or components implementing the connection building block;
or it is a configuration produced on initialization of the component or components implementing the connection building block;
or according to the type of access, bearing in mind that, preferably, command-type access can be subject to an application to the production—data transfers to an application—or on the consumption of the data, or independently, the application to the consumption of the data being preferred because it covers the possible loss of integrity during the storage phase.

In a first embodiment, the supervision function is activated on a time basis, linked to the production of the data by both data subsystems. There are two possible comparison granularities detailed below: either a word-for-word comparison or a word-group comparison. After reception of the first word from the first subsystem, the reception of the second word (a priori identical) from the second subsystem triggers the comparison. A minimum storage resource (size of the word) associated with each subsystem makes it possible to absorb any time offset between the production of the two words by the two subsystems. If the comparison detects a difference between the two words, an error is raised, the datum is not stored (therefore the transmission over the network or the local consumption by the two subsystems will not be performed). If the comparison does not detect any difference, one of the two occurrences (identical) of the word is stored in the exchange area for later consumption (transmission over the network or local consumption by the two subsystems). The transmitted word can be that from one of the mailboxes which is predetermined.

In a second embodiment, the supervision function is applied to the consumption of the datum either by the network subscriber or by the computation subsystems. This embodiment is preferred in as much as, ultimately, it is the consumed data that should be guaranteed integral. The data is consumed either by the network subscriber, according to a table that is specific to him and that may or may not be linked time-wise to the production, or by the computation subsystems. The comparison is linked time-wise to consumption: on a request to transmit a message from the network subscriber, the comparison function is applied. It is essential for the data to have been produced by each of the subsystems (“Refresh” information), the comparison being possible only on peer data previously produced by the processing subsystems. In the case where the datum/data could not be refreshed, the comparison function will not be triggered. There will therefore be no transmission by the network subscriber. The information transmitted over the network will necessarily be information that is refreshed and compared. The consumption by the computation subsystems is based on the same principle.

In a third embodiment, the supervision function is executed independently by the network subscriber. This embodiment makes it possible to relax the constraint of synchronization of the lanes. It does, however, require the provision of a comparison cycle consistent with the occurrences of the processing operations so as to compare identical data, that is, data obtained from the same production cycle. The supervision function is applied asynchronously to the operation of the two subsystems and the E/S. In network transmission mode, the two subsystems each transmit their message to their mailbox and indicate the refreshing thereof. The supervisor detects in its own cycle the refreshing of two peer messages and compares them. On a correct comparison, a transmit authorization indication is supplied for the E/S. The E/S then selects one of the two occurrences of the consolidated message. In network reception mode, the E/S stores two occurrences of the message, each in a mailbox. The supervisor detects in its own cycle the refreshing of two peer messages and compares them. On a correct comparison, a consumption authorization indication is supplied for the two subsystems. Each of the processing subsystems will acquire its own occurrence without the supervisor intervening, given the fact that the comparison has been performed.

Furthermore, either during certain equipment operating modes (for example, for a transitional mode for synchronization of the two subsystems), or for certain variables (status, byte information, certain I/O), the need not to activate the comparison to validate the authorization of the transfer emerges. In this case the transfer authorization should be configurable for certain data to be able to be different between the two computation subsystems, for example on startup, or on the sending of error messages—certain errors occurring time-wise only on one lane (e.g.: failure of a memory module). The activation or non-activation of the transfer function will then be based either on programming a global operating mode (for example startup mode versus operating mode), or by sorting on the data. The sort will preferably be performed according to the memory addressing of the variable (property of a variable, variable by variable: with or without comparison), a specific memory space being reserved for the data not affected by the supervision. From the point of view of the E/S module, the operation of the comparator can be described in the following way in transmit and receive modes. In network transmission mode, the E/S makes a request only to read a datum (at the most, of a size corresponding to a frame or fragment) from a port. The supervisor, on receiving this request, reads the two items of information produced by the two subsystems (access in two exchange areas). The supervisor performs the comparison of the data (data/fragment address) recovered in the two exchange areas. On a correct comparison, one of the two occurrences of the fragment is sent to the E/S for transmission. In network reception mode, the E/S performs its “redundancy management” task, that is, selects the first frame to arrive correctly (if RM deactivated: both frames will be stored). The E/S makes a storage request to the supervisor for each fragment received.

The supervisor can operate in two ways. Either it copies the storage request to the mailboxes. Each subsystem makes a request to read the message, and the requests will be compared. In return, the two occurrences recovered by the supervisor will be compared before provision (cross comparison). Or it stores the occurrence corresponding to the request in the mailbox. Each subsystem makes a request to read the message, and the requests will be compared. In return, the occurrence recovered by the supervisor is directly supplied to both subsystems.

Instead of performing the comparisons word-for-word, it is possible to perform them by groups of words. The number of words in each group should be chosen according to the desired performance level (integrity/availability and processing speed). In the case of a comparison by groups of words, the process is triggered after reception from both subsystems of the first word of a group. A minimum storage resource (size of the group of words) associated with each subsystem makes it possible to absorb any time offset between the production of the two groups of words. If the comparison detects a difference between the two groups, an error is raised, the data is not stored (therefore the transmission over the network or the local consumption by the two subsystems will not be performed). If the comparison detects no difference, one of the two (identical) groups of words is stored in the exchange area for subsequent consumption (transmission over the network or local consumption by the two subsystems). The group that is transmitted can be the one from a predetermined mlbx.

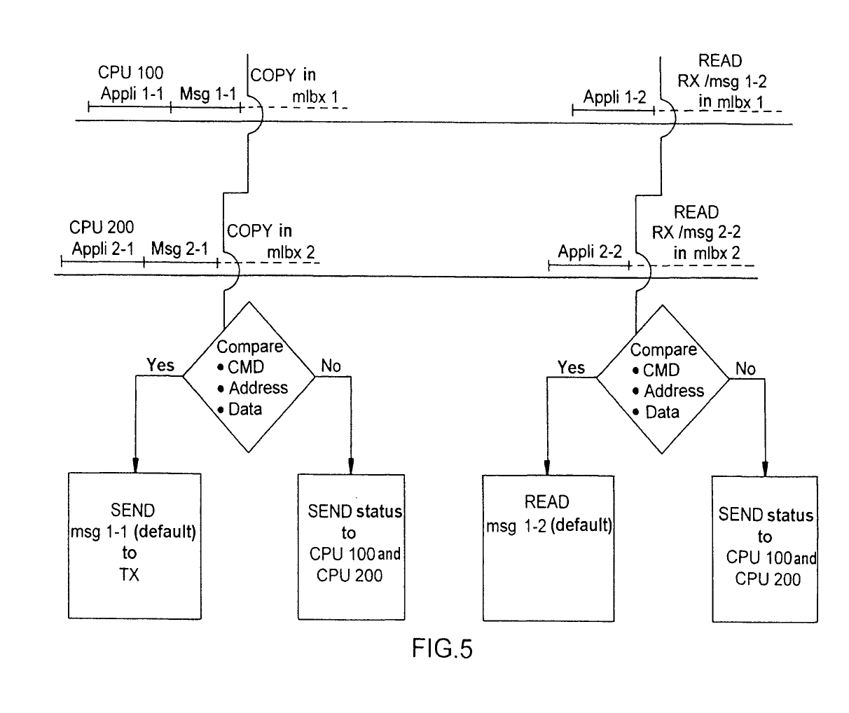

FIG. 5 represents a simplified flow diagram of the processing operations. The time progression is diagrammatically represented by the two axes on which are positioned the application executed respectively by the CPUs 100, 200. Appli1_1 is an application executed on the CPU 100 which requires the sending or reception of a message Msg1_1 to or from another local or remote application. Identically, Appli2_1 is an application executed on the CPU 200 which requires the sending or the reception of a message Msg2_1, normally identical to Msg1_1, to or from another application. This left-hand part of the figure illustrates the operating mode in which the supervision function is activated on the production of the data by the computation subsystems. The right-hand part of the figure illustrates the embodiment in which the supervision function is activated on the consumption of the data by the computation subsystems. In the first case, the transfer to the mlbx is performed by the COPY instruction. In the second case, the variable call to the mlbx is performed by the READ instruction. In both cases, the comparator is supplied with: the instruction, the address in the mlbx and the datum itself. These two records are compared bit-for-bit. In the case where the comparison is positive, the datum is transferred. When it is a question of supplying a produced datum, one of the two occurrences of the message—that designated by default—is sent to the network subscriber for transmission. When it is a question of consuming a datum called from another application, the mlbx designated by default is used to send the datum to both subsystems.

In the case where the comparison is negative, an error message is sent to both CPUs, the applications of which contain the routines needed to process the incident (ABORT for example).

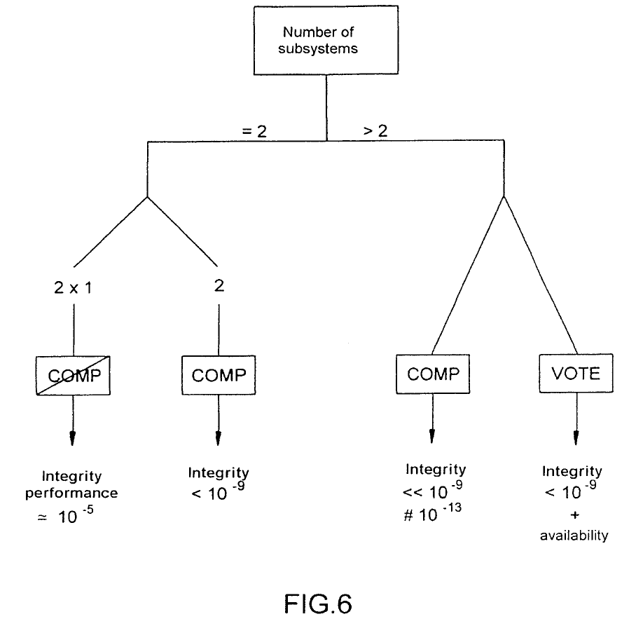

FIG. 6 represents various embodiments of the invention which are differentiated by the number of computation lanes and by the manner in which the supervision function is implemented.

In a two-lane architecture (left-hand part of the figure), it may be decided to operate in “dual-simplex” mode, that is, by executing the application only on one of the two computation lanes. In this case, the supervision function is disengaged. In an architecture with more than two lanes, it is possible to base the operation either on a comparison by means of strict bit-for-bit equality of the data from all the lanes, or to base it on a majority vote on the data from the various lanes. The first mode makes it possible to improve the integrity with respect to a two-lane structure. The second mode makes it possible to increase the availability while offering an integrity that is at least equal to that of the two-lane architecture. The physical architecture of the system is not different from the two-lane architecture. The comparator will have one of the architectures described hereinabove. It will be necessary to provide a mailbox of sufficient size to enable the comparison of the data on consumption, the size of the mailbox for an n-lane architecture being equal to n times that of a single-lane architecture.

These various embodiments with two or more than two lanes all fall within the scope of the protection claimed by the applicant.

What is claimed is:

1. A computer processing device comprising:
at least two computation sections, each provided with a central processing unit, said computation sections being synchronized with each other and having an area of random-access memory;
a data exchange memory for exchanging data between computation sections, the central processing units and an external communication network; and
a supervision module parameterizably supporting different methods of comparing the data of said computation sections.

2. The computer processing device according to claim 1, wherein said data exchange memory and said supervision module are incorporated within an interface management module connected to each of the computation sections and to the external communication network.

3. The computer processing device according to claim 1, wherein a comparison of the data of the two computation sections is performed by a bit-by-bit comparator having a parallel structure comprising an individual comparator for each data bit within groups of bits of parameterizable size.

4. The computer processing device according to claim 3, wherein the comparison function can be tested.

5. A method of processing at least one computer application running in parallel on at least two computation sections, each provided with a central processing unit, organized in partitions, said computation sections being synchronized with each other and having an area of random-access memory, said method comprising:
exchanging data between data exchange memory areas for exchanging data between partitions of a central processing unit and between the central processing units and an external communication network; and
supervising a parameterizable subset of said exchanges according to a criterion of comparison of the data of said computation sections.

6. The computer processing method according to claim 5, wherein the subset of the exchanges subject to comparison comprises all the data produced by the computation sections.

7. The computer processing method according to claim 5, wherein the subset of the exchanges subject to comparison comprises all the data consumed by the computation sections.

8. The computer processing method according to claim 5, wherein the subset of the exchanges subject to comparison comprises all the data present in the mailbox of the network subscriber at selected time slots.

9. The computer processing method according to claim 5, wherein the subset of the exchanges subject to comparison excludes programmed procedures of the computer application.

10. The computer processing method according to claim 5, wherein the subset of the exchanges subject to comparison excludes data with a reserved specific memory space.

11. The computer processing method according to claim 5, wherein a comparison according to the criterion of comparison is performed bit-by-bit within each word.

12. The computer processing method according to claim 5, wherein a comparison according to the criterion of comparison is performed bit-by-bit within each block of a predetermined number of words.

13. The computer processing method according to claim 5, wherein the method uses no more than two computation sections.

14. The computer processing method according to claim 13, wherein the transfer is not authorized if the data of the two computation sections that are compared are not identical.

15. The computer processing method according to claim 13, wherein the transfer is authorized if the data of the two computation sections that are compared are identical, the transmitted datum being that of one of the two computation sections for which the selection is parameterizable.

16. The computer processing method according to claim 5, wherein the method uses more than two computation sections.

17. The computer processing method according to claim 16, wherein the transfer is not authorized if no lane satisfies a vote criterion between the data of all the computation sections.

18. The computer processing method according to claim 16, wherein the transfer of the datum of a lane having satisfied a vote criterion between the data of all the computation sections is authorized.
